(19) United States
(12) Patent Application Publication
(10) Pub. No.: US 2024/0090578 A1
(43) Pub. Date: Mar. 21, 2024

(54) Aerosol Generating Device

(71) Applicant: JT International SA, Geneva (CH)

(72) Inventor: Herman Hijma, Kampen (NL)

(73) Assignee: JT International SA, Geneva (CH)

(21) Appl. No.: 18/274,919

(22) PCT Filed: Jan. 26, 2022
(86) PCT No.: PCT/EP2022/051758

§ 371 Date: Jul. 28, 2023

(30) Foreign Application Priority Data
Feb. 2, 2021 (EP) 21154826.8

(51) Int. Cl. A24F 40/465; A24F 40/20; H05B 6/10

(52) U.S. Cl. CPC A24F 40/465; A24F 40/20; H05B 6/105

(57) ABSTRACT

A heating apparatus for an aerosol generating device includes: a heating chamber for receiving an aerosol generating substrate; and a susceptor assembly including a first ring and a second ring and a plurality of susceptors held between the first and second rings. An aerosol generating system includes the heating apparatus in combination with an aerosol generating article.

### FIELD OF THE INVENTION

The present disclosure relates to an aerosol generating device. Such devices heat, rather than burn, an aerosol generating substrate, e.g., tobacco or other suitable materials, by conduction, convention, and/or radiation to generate an aerosol for inhalation by a user. The present disclosure is particularly applicable to a heating apparatus for an aerosol generating device.

### BACKGROUND

The popularity and use of reduced-risk or modified-risk devices (also known as aerosol generating devices or vapour generating devices) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device.

Currently available aerosol generating devices can use one of a number of different approaches to provide heat to the aerosol generating substrate. One such approach is to provide an aerosol generating device which employs an induction heating system. In such a device, an induction coil is provided in the device and an inductively heatable susceptor is provided to heat the aerosol generating substrate. Electrical energy is supplied to the induction coil when a user activates the device which in turn generates an alternating electromagnetic field. The susceptor couples with the electromagnetic field and generates heat which is transferred, for example by conduction, to the aerosol generating substrate and an aerosol is generated as the aerosol generating substrate is heated.

An object of the invention is to provide a more versatile aerosol generating device.

### SUMMARY OF THE INVENTION

According the present invention there is provided a heating apparatus for an aerosol generating device comprising: a heating chamber for receiving an aerosol generating substrate; and a susceptor assembly configured to be positioned within the heating chamber, the susceptor assembly comprising a first ring and a second ring, and a plurality of susceptors held between the first and second rings, wherein each susceptor in the plurality of susceptors extends from the first ring to the second ring, and wherein the susceptor assembly is configured to allow the aerosol generating substrate to pass through the first ring.

In this way each of the susceptors can be individually securely held together between the two rings as a unitary structure, which allows easy manufacture of the susceptor assembly/heating component and its installation into the heating chamber of the heating apparatus. In other words each susceptor may be considered as a susceptor branch that extends from and between the first and second rings. As such holding individual susceptors between the two rings provides structural support and integrity to each individual susceptor. Holding the plurality of susceptors between the rings can also minimise or prevent the length of each susceptor from being in contact with the heating chamber walls, such that any heat generated by the susceptors transfers less readily to the heating chamber walls and/or base. This improves the heating efficiency of the device by delivering more generated heat to the received aerosol generating substrate. Positioning the susceptors away from the heating chamber walls can also improve air flow into the heating chamber and delivery of generated aerosol to the user.

Using a plurality of susceptors also optimises heat distribution from each susceptor to an inserted aerosol generating substrate/consumable. For instance each susceptor will generate heat and reach a desired temperature more rapidly than a cylindrical or solid internal rod type susceptor for example, and thus transfer the generated heat to a consumable in a more efficient manner.

An aerosol generating substrate is typically a consumable that is inserted into a heating chamber by a user, where in use the consumable will be heated by the device to generate an aerosol. After the consumable is depleted or otherwise used, it is removed from the heating chamber and disposed of. Suitable aerosol generating substrates or consumables for the present heating apparatus and aerosol generating device will be apparent to the person skilled in the art.

Preferably the susceptor assembly is configured to be removable from the heating chamber. Preferably an outer surface the first ring and/or the second ring is configured to provide a frictional force which acts against an inner surface of the heating chamber. In this way the susceptor assembly may be effectively retained in the heating chamber for use, and also allow easy removal of the susceptor assembly for cleaning/changing. Removal of the susceptor assembly allows a user to effectively clean the susceptor assembly and chamber after use, and interchange different susceptor assembly configurations (e.g. an assembly with different number of, or differently shaped, susceptors) with a same aerosol generating device. The cross-sectional area of the second ring may be smaller than the cross-sectional area of the first ring so that removal of the assembly is easier, i.e. less or no frictional force is provided between the second ring and the inner heating chamber wall/surface.

Preferably the susceptor assembly is configured to prevent a received aerosol generating substrate from passing beyond the second ring. In this way a gap is provided between the closed end of the heating chamber and the inserted end of the aerosol generating substrate, thereby allowing, upon inhalation by the user, air to flow into the chamber along the outer surface of the aerosol generating substrate, and be drawn into the aerosol generating substrate and out toward the user's mouth, along with the generated vapour. The cross-sectional area of an aperture in the second ring may be smaller than the cross-sectional area of the aerosol generating substrate. Alternatively the second ring may comprise protrusions or a cross-shaped structure across the aperture to prevent the aerosol generating substrate from passing through. The second ring may comprise an outer circular shape or a polygonal shape.

Preferably the first ring and/or the second ring is configured to allow air to pass through or around the first and/or second ring after the aerosol generating substrate is received in the heating chamber. In this way the air flow in the heating chamber is better controlled. The insertion of the aerosol generating substrate into the heating chamber/susceptor assembly arrangement may allow air to flow into the chamber around the outer surface of the aerosol generating substrate and direct the air up and into the aerosol generating substrate via the distal/inserted end of the substrate. The first and/or second ring may comprise venting gates or apertures to allow air to pass through the body of the ring. Alternatively the first and/or second ring may be shaped to allow air to pass around the outer edge of the ring. For example the ring may have a hexagonal outer periphery which fits in a circular inner periphery of the heating chamber.

Preferably each end of the plurality of susceptors is arranged at the respective first ring and/or the second ring. In this way a simple construction of the susceptor assembly is provided. The first and/or second ring may be overmoulded on each respective end of the plurality of susceptors. Alternatively the ring may comprises respective slots into which a susceptor end is inserted/fitted.

Preferably a first end of each susceptor is arranged at the second ring, and a portion of the first end of at least one of the plurality of susceptors held in the second ring is substantially perpendicular to a direction in which the susceptor assembly is removed from the heating chamber. In this way the second ring is more securely fastened to the plurality of susceptors, such that effective removal of the unitary susceptor assembly is ensured. The end of the susceptor may be bent before being attached or held in the second ring, or alternatively, during manufacture the second ring may first be arranged away from the susceptor end (in a overmoulded or slotted/inserted manner) and the susceptor end is folded back toward the second ring.

Preferably at least one of the heating chamber, the first ring and/or the second ring comprise a substantially non-electrically conductive and non-magnetically permeable material. In this way the heat generating by the plurality of susceptors may be better contained within the heating chamber and delivered to a received aerosol generating substrate. The substantially non-electrically conductive and non-magnetically permeable material may be a polymer material. The heating chamber, first and/or second ring may comprise a heat-resistant plastics material, such as polyether ether ketone (PEEK). In addition rings comprising the polymer material may be easily moulded over the susceptors. A susceptor assembly comprising polymer material rings may also be readily pressed into the heating chamber to ensure a tight fit or seal against the interfacing surfaces.

Preferably at least one susceptor comprises an inwardly extending portion, positioned between the first and second rings, that extends toward a central axis of the heating chamber so as to provide a reduced cross-sectional area of the heating chamber. In this way the inwardly extended susceptor portion can push against an aerosol generating substrate received in the heating chamber to form a friction fit and provide an improved grip on the substrate, thereby reducing the risk of the received substrate from falling out of the device.

Preferably each of the susceptors is spaced apart from an inner heating chamber wall between the first and second rings. In this way a more efficient heating apparatus is provided since heat generated by the susceptors are better delivered to a received aerosol generating substrate, and less heat is lost to the inner heating chamber wall.

Preferably each of the susceptors is in contact with an inner heating chamber wall along at least one edge. In this way the susceptors can be shaped to increase the contact area or heat transfer area of the susceptors to an aerosol generating substrate. The edge in contact with the heating chamber wall provides reinforcement (i.e. structural rigidity) to the susceptors whilst minimising heat loss via conduction. For instance the susceptor may have a ridge cross-section where the crest of the ridge points towards the inner chamber wall.

Preferably each of the susceptors is in contact with an inner heating chamber wall along at least two edges, but are spaced apart from the heating chamber wall between the two edges. In this way the susceptors can be shaped to provide an intensified contact area or heat transfer area of the susceptors with an inserted aerosol generating substrate. For example the susceptor may have a ridge cross-section where the crest of the ridge points toward a centreline of the heating chamber (into an aerosol generating substrate), and where the slopes of the ridge shape cause two edges to be in contact with the heating chamber wall. This arrangement provides reinforcement to the susceptors whilst minimising heat loss via conduction.

Preferably each of the susceptors have a convex cross-sectional shape so as to minimise contact with an inner heating chamber inner wall, and to improve structural rigidity. In this way a susceptor can be shaped to increase the heat transfer area of the susceptors to an aerosol generating substrate or to provide an intensified heat transfer area of the susceptors with an inserted aerosol generating substrate. The convex cross-sectional shape provides structural rigidity to the susceptors whilst also minimising heat loss via conduction.

Preferably the heating chamber comprises a chamber wall configured to support an induction heating coil of an electromagnetic field generator. The chamber wall may include a coil support structure which may be formed in or on an outer surface for supporting an induction heating coil of an electromagnetic field generator. The coil support structure facilitates mounting of the induction heating coil and allows the induction heating coil to be positioned optimally with respect to the susceptors. The susceptors are, therefore, heated efficiently, thereby improving the energy efficiency of the heating apparatus. The provision of the coil support structure also facilitates manufacture and assembly of the heating apparatus.

According to another aspect of the invention there is provided an aerosol generating system comprising: an aerosol generating substrate; an electromagnetic field generator; and a heating apparatus according to the first aspect.

### BRIEF DESCRIPTION OF THE DRAWINGS

Embodiments of the invention are described below by way of example with reference to the drawings, in which:

FIG. 1A is a schematic cross-sectional view of an aerosol generating system according to a first embodiment of the invention, the aerosol generating system comprising a heating apparatus according to the invention, and an aerosol generating substrate for inserting into the heating apparatus;

FIG. 1B is a schematic cross-sectional view of the aerosol generating system of FIG. 1A, showing the aerosol generating substrate positioned in the heating apparatus;

FIG. 2A is a schematic view of a susceptor assembly according to a second embodiment of the invention;

FIG. 2B is a schematic view of the heating apparatus of the second embodiment of the invention surrounded by an induction coil;

FIG. 3A is a top view of another susceptor assembly according to a third embodiment of the invention;

FIG. 3B is a side view of the susceptor assembly according to the third embodiment of the invention;

FIG. 3C a side view of a heating apparatus according to the third embodiment of the invention;

FIG. 3D is another side view of the susceptor assembly according to the third embodiment of the invention with an aerosol generating substrate received within;

FIG. 4A is a side view of another susceptor assembly according to a fourth embodiment of the invention;

FIG. 4B is an end view of the susceptor assembly of the fourth embodiment of the invention;

FIG. 4C is another schematic end view of the susceptor assembly of the fourth embodiment of the invention with an aerosol generating substrate received within;

FIG. 5A is a schematic view of a susceptor arrangement according to a fifth embodiment of the invention;

FIG. 5B is another schematic view of the susceptor arrangement of the fifth embodiment of the invention comprising an end connector ring;

FIG. 5C is another schematic end view of the susceptor arrangement of the fifth embodiment of the invention with an aerosol generating substrate received within;

FIG. 6A is a schematic view of another susceptor assembly according to a sixth embodiment of the invention;

FIG. 6B is a schematic view of the end connector ring of the susceptor assembly of the sixth embodiment of the invention;

FIG. 6C is another schematic view of the end connector ring of the sixth embodiment of the invention;

FIG. 6D is another schematic view of the end connector ring of the sixth embodiment of the invention;

FIG. 6E is another schematic view of the end connector ring of the sixth embodiment of the invention;

FIG. 7 is a schematic view of another end connector ring of a susceptor assembly according to a seventh embodiment of the invention;

FIG. 8A is a schematic of a susceptor assembly according to an eighth embodiment of the invention;

FIG. 8B is a cross-sectional schematic view of a heating apparatus according to the eighth embodiment of the invention;

FIG. 8C is an upper-section schematic view of the susceptor arrangement of the eighth embodiment of the invention;

FIG. 8D is a mid-section schematic view of the heating apparatus of the eighth embodiment of the invention; and

FIG. 8E is an end-section schematic view of the heating apparatus of the eighth embodiment of the invention.

### DETAILED DESCRIPTION

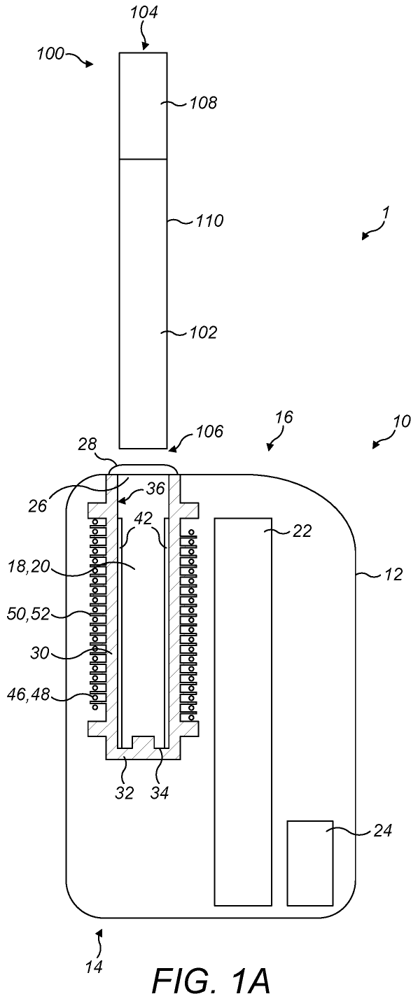

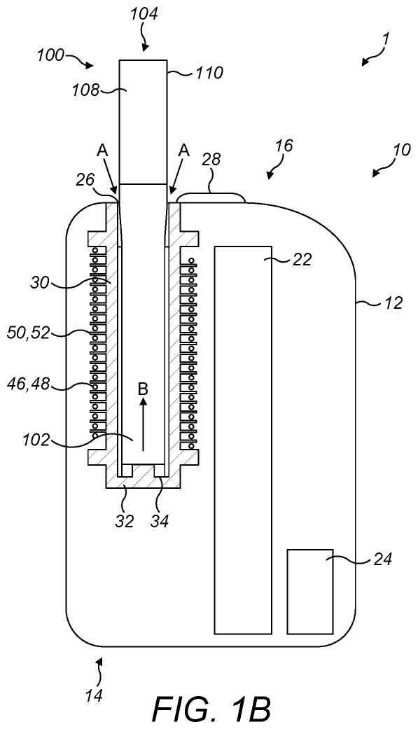

FIGS. 1A and 1B show an aerosol generating system 1, which comprises an aerosol generating device 10 and an aerosol generating article 100 for use with the device 10. The aerosol generating device 10 comprises a main body 12 housing various components of the aerosol generating device 10. The main body 12 can have any shape that is sized to fit the components described in the various embodiments set out herein and to be comfortably held by a user unaided, in a single hand.

A first end 14 of the aerosol generating device 10, shown towards the bottom of FIGS. 1A and 1B, is described for convenience as a distal, bottom, base or lower end of the aerosol generating device 10. A second end 16 of the aerosol generating device 10, shown towards the top of FIGS. 1a and 1b, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth.

The aerosol generating device 10 comprises a heating chamber 18 positioned in the main body 12. The heating chamber 18 defines an interior volume in the form of a cavity 20 having a substantially cylindrical cross-section for receiving an aerosol generating article 100. The heating chamber 18 has a longitudinal axis defining a longitudinal direction and is formed of a heat-resistant plastics material, such as polyether ether ketone (PEEK). The aerosol generating device 10 further comprises a power source 22, for example one or more batteries which may be rechargeable, and a controller 24.

The heating chamber 18 is open towards the second end 16 of the aerosol generating device 10. In other words, the heating chamber 18 has an open first end 26 towards the second end 16 of the aerosol generating device 10. The heating chamber 18 is typically held spaced apart from the inner surface of the main body 12 to minimise any heat transfer to the main body 12.

The aerosol generating device 10 can optionally include a sliding cover 28 movable transversely between a closed position (see FIG. 1A) in which it covers the open first end 26 of the heating chamber 18 to prevent access to the heating chamber 18 and an open position (see FIG. 1B) in which it exposes the open first end 26 of the heating chamber 18 to provide access to the heating chamber 18.

The heating chamber 18, and specifically the cavity 20, is arranged to receive a correspondingly shaped generally cylindrical or rod-shaped aerosol generating article 100. Typically, the aerosol generating article 100 typically comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The aerosol generating article 100 further comprises a mouthpiece segment 108 positioned downstream of the aerosol generating substrate 102. The aerosol generating substrate 102 and the mouthpiece segment 108 are arranged in coaxial alignment inside a wrapper 110 (e.g., a paper wrapper) to hold the components in position to form the rod-shaped aerosol generating article 100.

The heating chamber 18 has a side wall (or chamber wall) 30 extending between a base 32, located at a second end 34 of the heating chamber 18, and the open first end 26. The side wall 30 and the base 32 are connected to each another and can be integrally formed as a single piece. In FIGS. 1A and 1B, the side wall 30 is tubular and, more specifically, cylindrical. In other examples, the side wall 30 can have other suitable shapes, such as a tube with an elliptical or polygonal cross section. The side wall 30 can also be tapered.

The base 32 of the heating chamber 18 is closed, e.g. sealed or air-tight. That is, the heating chamber 18 is cup-shaped. This can ensure that air drawn from the open first end 26 is prevented by the base 32 from flowing out of the second end 34 and is instead guided through the aerosol generating substrate 102, back up toward a user. It can also ensure that a user inserts the aerosol generating article 100 into the heating chamber 18 an intended distance and no further.

The side wall 30 of the heating chamber 18 has an inner surface 36 and an outer surface 38. The aerosol generating device 10 comprises an electromagnetic field generator 46 for generating an electromagnetic field. The electromagnetic field generator 46 comprises a substantially helical induction coil 48. The induction coil 48 has a circular cross-section and extends helically around the substantially cylindrical heating chamber 18. The induction coil 48 can be energised by the power source 22 and controller 24. The controller 24 includes, amongst other electronic components, an inverter which is arranged to convert a direct current from the power source 22 into an alternating high-frequency current for the induction coil 48.

The side wall 30 of the heating chamber 18 includes a coil support structure 50 formed in the outer surface 38. In the illustrated example, the coil support structure 50 comprises a coil support groove 52 which extends helically around the outer surface 38. The induction coil 48 is positioned in the coil support groove 52 and is, thus, securely and optimally positioned with respect to a susceptor assembly 42.

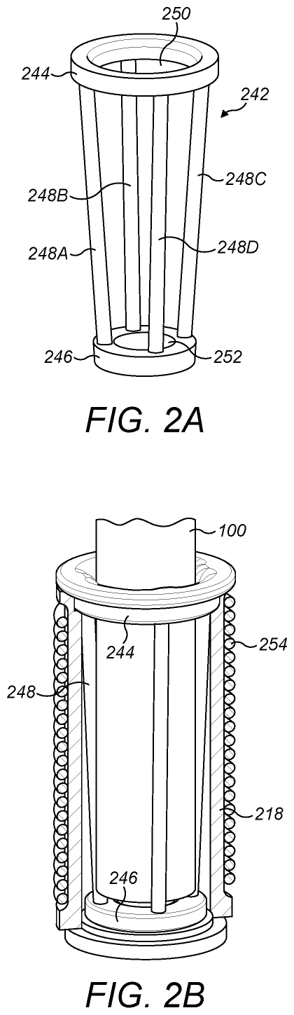

FIGS. 2 to 8 illustrate different configurations of a removable susceptor assembly of the present invention suitable to be positioned within the heating chamber 18 of FIGS. 1A and 1B.

FIG. 2A shows a perspective view of a susceptor assembly 242 comprising an upper connector ring 244, a lower connector ring 246 and four inductively heatable susceptor rods 248A, 248B, 248C, 248D held between the upper and lower connector rings. The susceptor assembly 242 can be positioned within the heating chamber 18 in FIG. 1. The upper connector ring 244 has a larger diameter than the lower connector ring 246. The upper ring 244 has a central hole 250 that is configured to allow an aerosol generating article 100 to pass through the central hole 250, and the lower ring 246 has a central hole 252 which prevents an inserted aerosol generated article 100 from passing beyond the lower ring 246, as shown in FIG. 2B. The susceptor rods 248 therefore are angled relative to a central longitudinal axis of the susceptor assembly 242 such that the susceptors 248 extend toward the central axis from the upper ring 244 to the lower ring 246.

FIG. 2B shows a perspective view of the susceptor assembly 242 provided in a heating chamber 218. The upper connector ring 244 comprises a lip which is configured to sit on the heating chamber wall 218 at its opening. An induction coil 254 is arranged to extend helically around the outside of the heating chamber 218. An aerosol generating article 100 is inserted in the heating chamber 218 and susceptor assembly 242 via the upper ring 244 to be heated by the susceptor rods 248. The lower ring 246 of the susceptor assembly 242 is shaped such that the inserted end of the aerosol generating article 100 abuts the lower ring 246 and is prevented from passing beyond the lower ring 246. It can be seen in FIG. 2B that the susceptor rods 248 extend away from the side wall of the heating chamber 218, moving from the upper ring 244 to the lower ring 246.

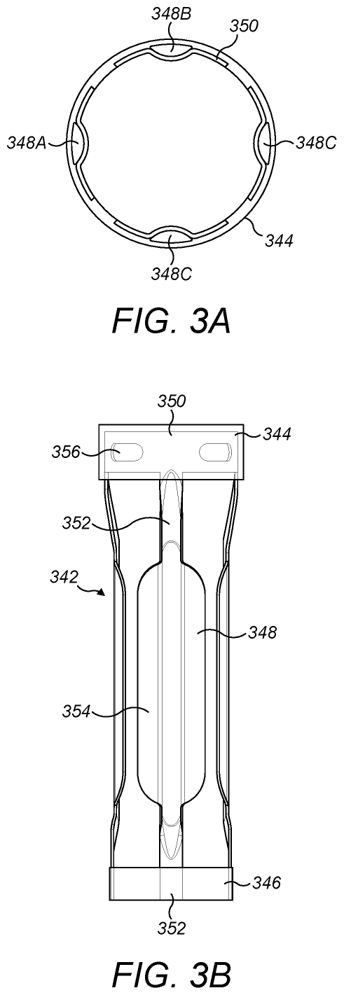

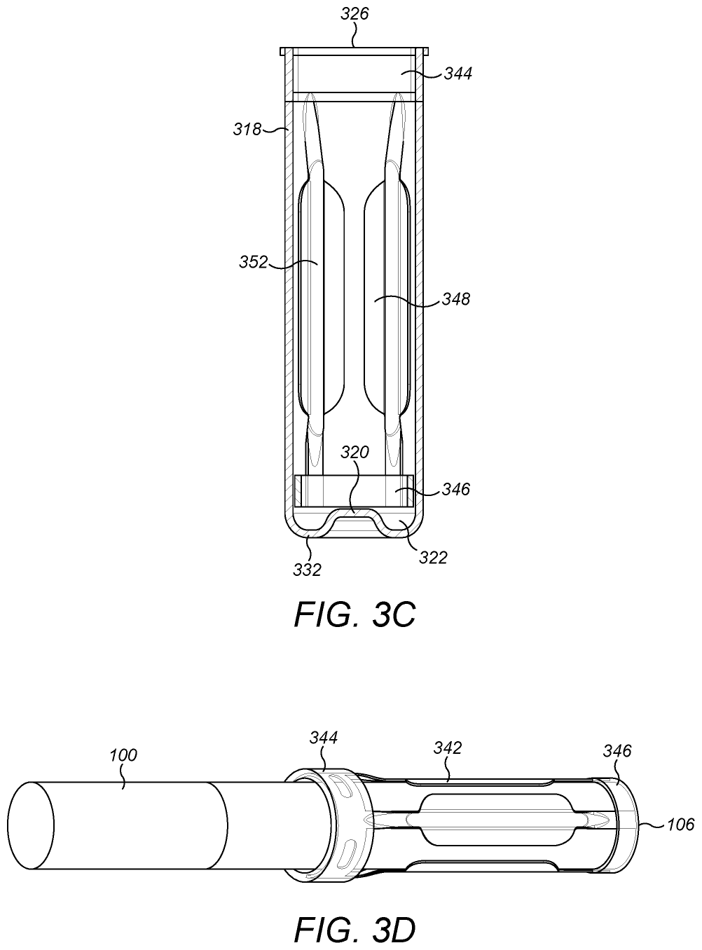

FIGS. 3A to 3D show various views of a susceptor assembly 342 according to another embodiment of the invention. FIGS. 3A and 3B show a top view and side view of the susceptor assembly 342 respectively, FIG. 3C show a side view of a heating apparatus comprising the susceptor assembly 342 provided within a heating chamber 318, and FIG. 3D shows a perspective view of the susceptor assembly 342 with an aerosol generating substrate received in the assembly.

The susceptor assembly 342 comprises an upper connector ring 344, a lower connector ring 346 and four inductively heatable susceptor branches 348A, 348B, 348C, 348D held between the upper and lower rings. The branches 348A, 348B, 348C, 348D are evenly spaced and circumferentially spaced around the rings such that two branches 348A/348C and 348B/348D face each other on opposite sides of the rings.

The upper and lower connector rings 344, 346 are made of a polymeric material that is substantially non-electrically conductive and non-magnetically permeable, such as polyether ether ketone (PEEK). When the susceptor assembly 342 is pressed into the heating chamber 318, the upper ring 344 provides a friction fit around its entire outer periphery with the side wall of the heating chamber 318. The upper connector ring 344 has a larger diameter than the lower connector ring 346, such that the upper ring 244 allows an aerosol generating article 100 to pass through a central hole of the upper ring 344, and the lower ring 246 prevents an inserted aerosol generated article 100 from passing beyond the lower ring 246, as shown in FIG. 3D.

The susceptor assembly 342 can be readily removed from the heating chamber 318 by pulling on the upper ring 344. In use an aerosol generating article 100 is inserted into the heating chamber 218 through the central opening of the outer ring 254. The upper ring 344 and lower ring 346 comprise venting gates (not shown) such that when an aerosol generating article 100 is in the susceptor assembly 342 and a user inhales air passes through the venting gates, along the outer surface of inserted aerosol generating article 100, and return through the aerosol generating article via the inserted end of the aerosol generating article.

Each of the susceptor branches 348A, 348B, 348C, 348D comprises an upper bracket 350, a central stem portion 352 and a blade portion 354. The upper bracket 350 of each branch is held within the upper connector ring 344. Each upper bracket 350 comprises holes 356 which strengthen the mechanical bond between the upper bracket 350 and the upper ring 344 where during the forming process the material of the upper ring 344 would flow through the holes 356 and solidify.

Each central stem portion 352 extends from the upper bracket 350 (and upper ring 344) and is embedded in the lower connector ring 346. A portion of the stem 352 is angled inwardly toward the central longitudinal axis of the susceptor assembly 342 along the direction extending away from the upper connector ring 344 to join the susceptor branch stem to the lower connector ring 346 of smaller diameter. The central stem 352 has a curved profile along its exposed length, between the upper and lower connector rings, which acts as a reinforced shaft to provide structural rigidity to the branch 348. The groove shape of the stem 352 points inwardly toward the centre of the susceptor assembly 342 and provides a strip of intensified contact to a received aerosol generating article by pushing into the side of the aerosol generating article more deeply.

The blade portion 354 of each branch 348 is arranged along the central stem 352 such that the blade 354 extends radially from either side of the stem 352. The blade 354 has a pill/capsule shape, i.e. an elongated circle, with the central stem 352 passing through the rounded ends of the blade 354. Each blade 354 is also curved to form a cupped shape like a portion of a capsule. The curvature of the blade 354 is selected such that the inner surface of the blade 354 is in contact and cups a received aerosol generating article.

As can be seen in FIG. 3C the susceptor assembly 342 is positioned within the heating chamber 318 such that the upper connector ring 344 is arranged at the open end 326 of the heating chamber 318 and the branches 348A, 348B, 348C, 348D extend away from the open end 326 towards the base 332 of the heating chamber 318. In other words the susceptor branches 348A, 348B, 348C, 348D are elongate in the longitudinal direction of the heating chamber 318. The lower connector ring 346 is positioned toward the base 332 of the heating chamber 318. The base 332 of the heating chamber 318 comprises a protrusion 320 in the centre of the base 332 that extends inwardly into the heating chamber 318. The protrusion 320 acts as an insertion limiter for the lower connector ring 346 and/or an aerosol generating substrate/article 100 that is received into the chamber 318 and provides a gap 322 between the distal end 106 of the article 100 and the main base wall 332 to allow air drawn into the heating chamber 318 to travel along the outer surface of the article 100 toward the base 332 to return up through the article 100 via the distal end 106 of the aerosol generating article 100.

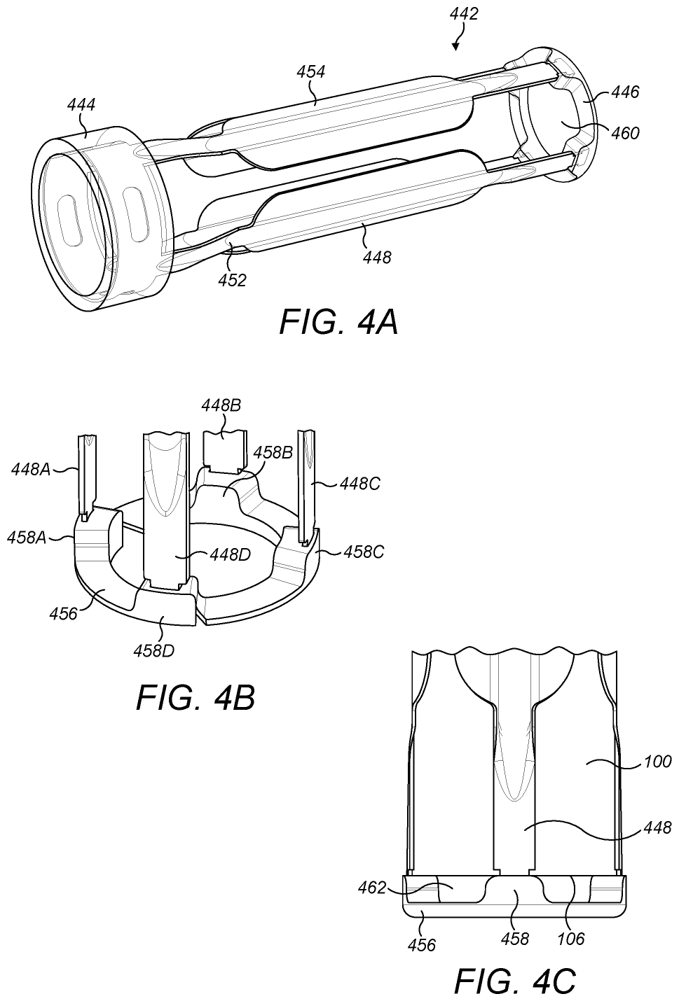

FIGS. 4A to 4C show various views of a susceptor assembly 442 according to another embodiment of the invention. FIG. 4A shows a side view of the susceptor assembly 442, FIG. 4B shows a perspective view of the lower end of the susceptor assembly 442, and FIG. 4C shows a side view of the lower end of the susceptor assembly 442 with an aerosol generating article positioned in the assembly.

The susceptor assembly 442 construction in FIG. 4 is similar to the embodiment described with reference to FIG. 3. The susceptor assembly 442 comprises an upper connector ring 444, a lower connector ring 446 and susceptor branches 448A, 448B, 448C, 448D held between the two rings. Each susceptor branch 448 comprises a stem portion 452 and a blade portion 454.

As can be seen more clearly in FIGS. 4B and 4C, the lower connector ring 446 has a thin ring shape 456 with four projections 458A, 458B, 458C, 458D, or mounds, arranged on a major surface of the lower ring 446, facing the upper connector ring 444. The stems 452 of the branches 448A, 448B, 448C, 448D and held in the corresponding projections 458A, 458B, 458C, 458D toward the outer edge of the lower ring 446, and the remaining top surface of the projections 458A, 458B, 458C, 458D form an insertion limiter against which an inserted end of an aerosol generating article 100 would abut (as shown in FIG. 4C). It should be understood that the central hole 460 of the lower connector ring 446 has a smaller diameter than the diameter of the aerosol generating article 100 to ensure that the aerosol generating article 100 would abut against the projections 458A, 458B, 458C, 458D and not pass beyond the lower connector ring 446.

The projections 458A, 458B, 458C, 458D also provide venting gates 462, or gaps which allow air to pass radially through from the outer surface of an aerosol generating article into the central face of the distal end 106 of the aerosol generating article 100. This means that the susceptor assembly 442 can be provided within a heating chamber with a flat base wall and allow air to flow freely to the inserted end of an aerosol generating article.

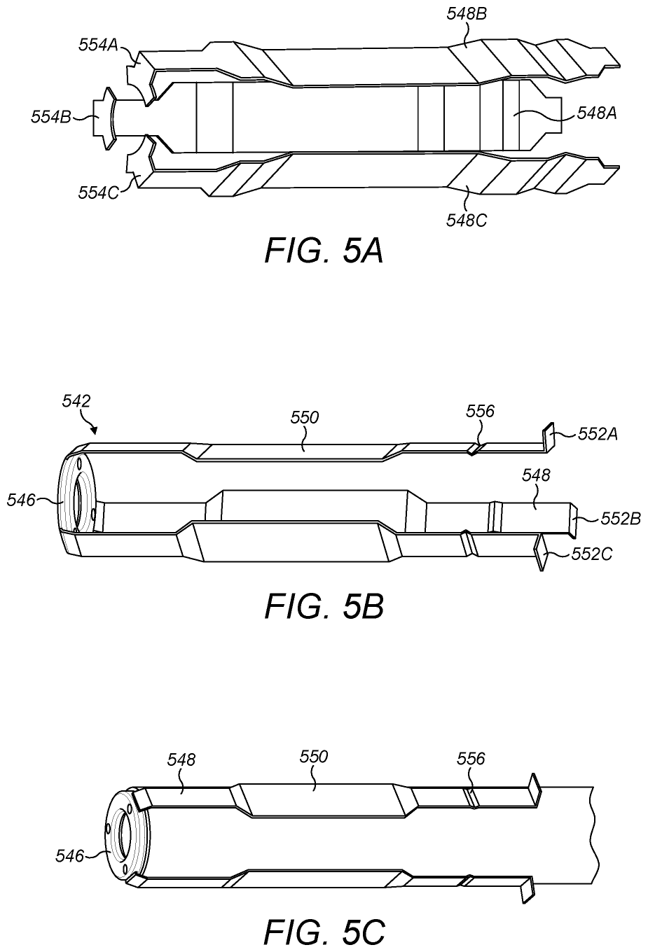

FIGS. 5A to 5C show various views of a susceptor arrangement 542 according to another embodiment of the invention. FIG. 5A shows an arrangement of three susceptor branches 548A, 548B, 548C, FIG. 5B shows the susceptor arrangement 542 with a lower connector ring 546, and FIG. 5C shows the susceptor arrangement 542 with a lower connector ring 546 and an aerosol generating article received within the susceptor branches.

The susceptor branches 548A, 548B, 548C have a main inwardly extending portion 550, or blade portion, that extends into the centre of the heating chamber from its side wall, for example to compress an aerosol generating article/substrate. The inwardly extending portion 550 forms a friction fit with the aerosol generating substrate and provide the heating chamber with a reduced cross-sectional area which thereby compresses an aerosol generating substrate positioned, in use, in the heating chamber. By compressing the aerosol generating substrate, heat can be transferred more efficiently to the aerosol generating substrate and more rapid heating can be achieved, whilst at the same time maximising energy efficiency.

The upper ends 552A, 552B, 552C and lower ends 554A, 554B, 554C of the susceptor branches 548A, 548B, 548C are bent/folded such that they are arranged perpendicularly to the major faces of the respective rings before the rings are overmoulded onto the susceptor branch ends. It should be understood that the ends of the susceptor branches are also arranged perpendicular to the direction of insertion/extraction of the susceptor assembly 542 into a heating chamber, which reduces the risk of detachment of a susceptor branch from a connector ring during extraction. Each susceptor branch 548A, 548B, 548C also comprises a radial groove 556, across a width of the branch, which further stabilises and provides structural rigidity to the branch.

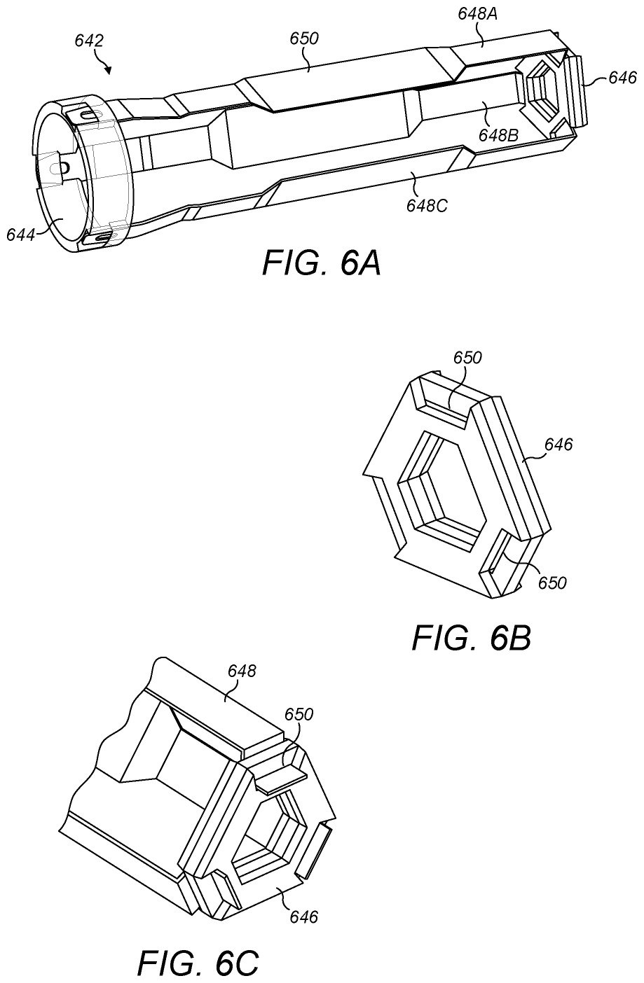

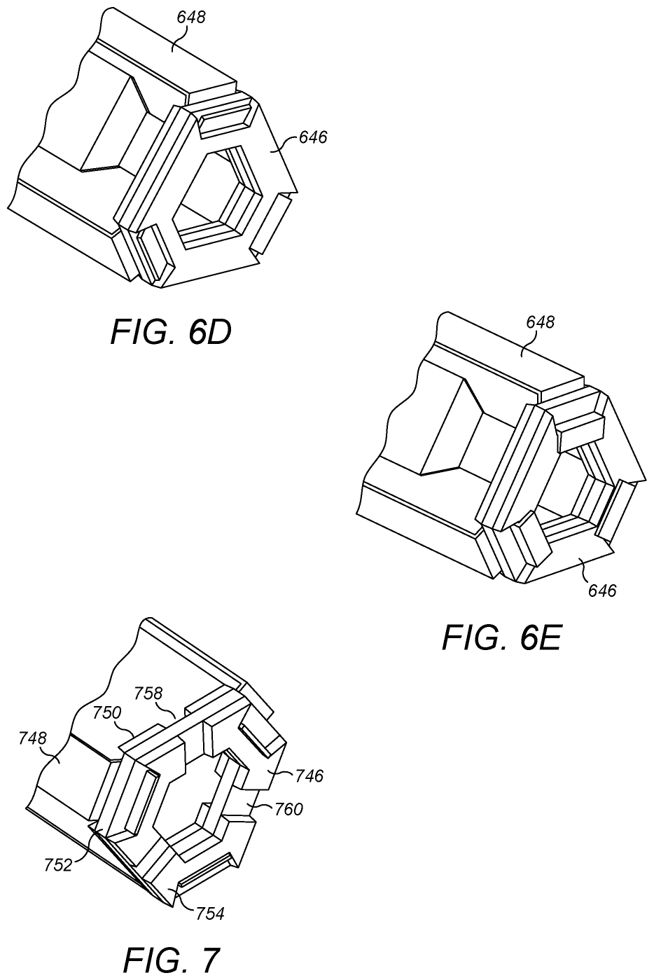

FIGS. 6A to 6E show various views of a susceptor assembly 642 according to another embodiment of the invention. FIG. 6A shows a perspective view of the susceptor assembly 642 having an upper connector ring 644, a lower connector ring 646 and three susceptor branches 648A, 648B, 648C. FIG. 6B shows a separate lower connector ring 646, and FIGS. 6C, 6D and 6E show how the susceptor branches slot and fold around the lower connector ring 646.

The susceptor assembly 642 construction in FIG. 6 is similar to the embodiment described with reference to FIG. 5, where the susceptor branches 648A, 648B, 648C each have a main inwardly extending portion 650, or blade portion, that extends into a heating chamber from the side wall.

The lower connector ring 646 has a polygonal shape, like a truncated triangle. The straight sides of the lower connector ring 646 mean that air can easily flow around the outer edge of the susceptor assembly 642 and lower connector ring 646 to the base of a heating chamber.

The lower connector ring 646 has a layered construction with slots 650 for the ends of the susceptor branches 648A, 648B, 648C to pass through as shown in FIG. 6C. After passing through the slots 650, the susceptor branch ends can be folded inwardly as in FIG. 6D or outwardly as in FIG. 6E to secure the susceptor branches to the lower ring 646.

FIG. 7 shows a perspective view of another polygonal lower connector ring 746. The lower connector ring 746 comprises an upper layer 750, a middle layer 752 and a bottom layer 754. The middle layer 752 has slots 756 for the susceptor branches 748 to pass through. The upper layer 750 of the lower ring comprises radial venting gates 758 which create an airflow gap between the inserted end of an aerosol generating article and the lower ring 746. The bottom layer 754 of the lower ring 746 also comprises radial venting gates 760 which create an airflow gap between the lower ring 746 and the base wall of a heating chamber. The radial venting gates 758, 760 can therefore optimise airflow in a heating chamber-susceptor assembly arrangement.

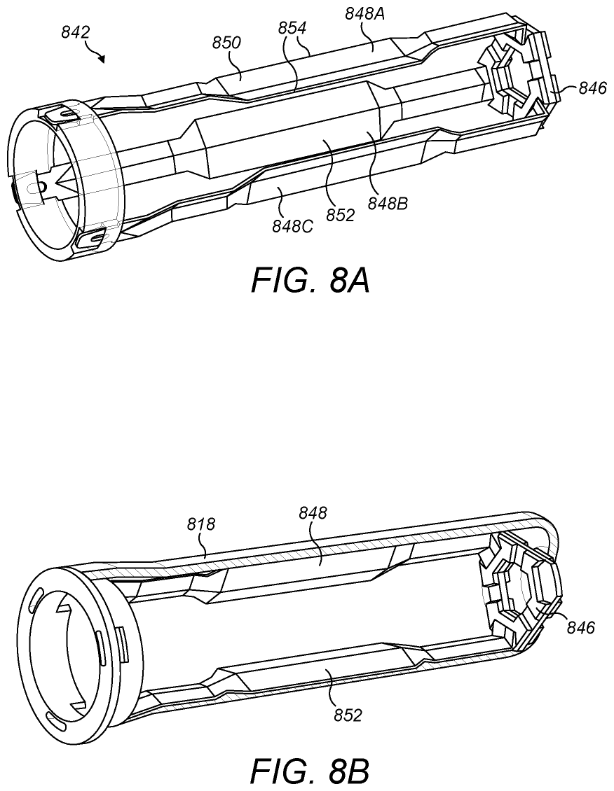

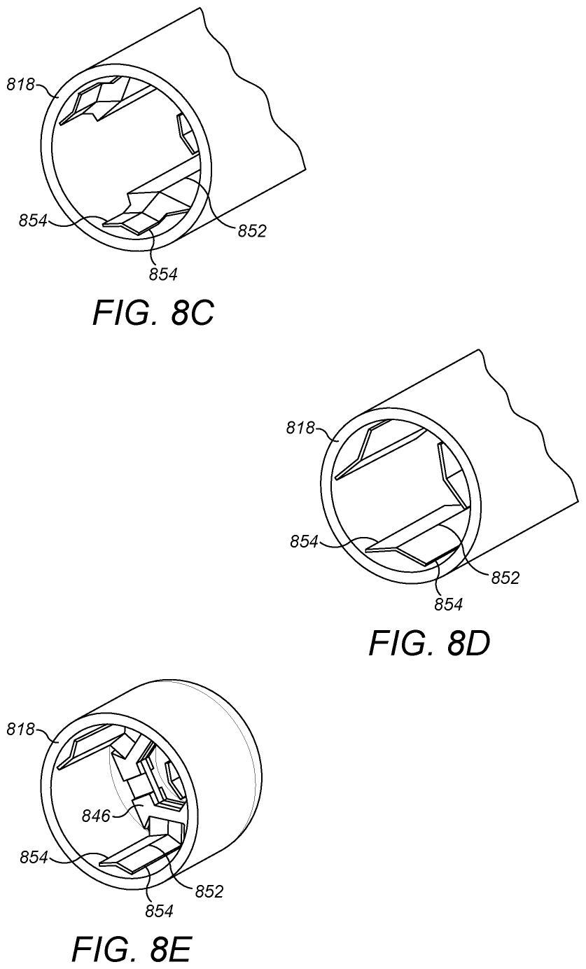

FIGS. 8A to 8E show various views of a susceptor assembly 842 according to another embodiment of the invention. FIG. 8A shows a perspective view of the susceptor assembly 842, FIG. 8B shows a partial susceptor assembly 842 in a longitudinally cross-sectioned heating chamber 818, and FIGS. 8C, 8D and 8E show top, mid- and lower cross-sectional views of the susceptor assembly 842 in the heating chamber 818 along the length of the heating chamber respectively.

The susceptor assembly 842 construction in FIG. 8 is similar to the embodiment described with reference to FIGS. 5 and 7, where the susceptor branches 848A, 848B, 848C each have a main inwardly extending portion 850, or blade portion, that extends into a heating chamber from the side wall. The lower connector ring 846 is similar to the vented polygonal lower connector ring as described with reference to FIG. 7.

Each susceptor branch 848A, 848B, 848C is folded or kinked across its full length to form a ridge 852, where the crest of the ridge points inwardly toward the centre of the heating chamber 818, and the edges 854 of the folded susceptor branch 848 have minimal contact with the side wall of the heating chamber 818, should an inserted aerosol generating article cause the susceptor branches 848 to flex outwardly toward the heating chamber wall. The folded shape of the susceptor branches provide additional structural rigidity, and the contact of the edges 854 with the heating chamber is minimal and reduces heat loss via conduction. As can be seen in FIGS. 8C to 8E, by holding the susceptor branches 848 between upper and lower connector rings the susceptor branches are separated from the walls of the heating chamber 818 which improves air flow in the heating chamber as well as improves heating efficiency.

It should be appreciated that any combination of the above-described features in all possible variations thereof is encompassed by the present disclosure unless otherwise indicated herein or otherwise clearly contradicted by context.

1. A heating apparatus for an aerosol generating device comprising:
a heating chamber for receiving an aerosol generating substrate; and
a susceptor assembly configured to be positioned within the heating chamber, the susceptor assembly comprising a first ring and a second ring, and a plurality of susceptors held between the first and second rings, wherein each susceptor in the plurality of susceptors extends from the first ring to the second ring, and wherein the susceptor assembly is configured to allow the aerosol generating substrate to pass through the first ring.

2. The heating apparatus of claim 1, wherein the susceptor assembly is configured to be removable from the heating chamber.

3. The heating apparatus of claim 2, wherein an outer surface of the first ring and/or an outer surface of the second ring is configured to provide a frictional force which acts against an inner surface of the heating chamber.

4. The heating apparatus of claim 1, wherein the susceptor assembly is configured to prevent a received aerosol generating substrate from passing beyond the second ring.

5. The heating apparatus of claim 1, wherein the first ring and/or the second ring is configured to allow air to pass through or around the first ring and/or the second ring after the aerosol generating substrate is received in the heating chamber.

6. The heating apparatus of claim 1, wherein each end of the plurality of susceptors is arranged at the respective first ring and/or the second ring.

7. The heating apparatus of claim 2, wherein a first end of each susceptor in the plurality of susceptors is arranged at the second ring, and a portion of the first end of at least one of the plurality of susceptors held in the second ring is substantially perpendicular to a direction in which the susceptor assembly is configured to be removed from the heating chamber.

8. The heating apparatus of claim 1, wherein at least one of the heating chamber, the first ring and/or the second ring comprises a substantially non-electrically conductive and non-magnetically permeable material.

9. The heating apparatus of claim 1, wherein at least one susceptor in the plurality of susceptors comprises an inwardly extending portion, positioned between the first and second rings, that extends toward a central axis of the heating chamber so as to provide a reduced cross-sectional area of the heating chamber.

10. The heating apparatus of claim 1, wherein each of the susceptors in the plurality of susceptors is spaced apart from an inner heating chamber wall between the first and second rings.

11. The heating apparatus of claim 1, wherein each of the susceptors in the plurality of susceptors is in contact with an inner heating chamber wall along at least one edge.

12. The heating apparatus of claim 1, wherein each of the susceptors in the plurality of susceptors is in contact with an inner heating chamber wall along at least two edges, but are spaced apart from the heating chamber wall between the at least two edges.

13. The heating apparatus of claim 1, wherein each of the susceptors in the plurality of susceptors has a convex cross-sectional shape so as to minimise contact with an inner heating chamber inner wall, and to improve structural rigidity.

14. The heating apparatus of claim 1, wherein the heating chamber comprises a chamber wall configured to support an induction heating coil of an electromagnetic field generator.

15. An aerosol generating system comprising:
an aerosol generating substrate;
an electromagnetic field generator; and
the heating apparatus of claim 1.
